(19) United States
(12) Patent Application Publication
(10) Pub. No.: US 2012/0004846 A1
(43) Pub. Date: Jan. 5, 2012

(54) AIR NAVIGATION DEVICE WITH INERTIAL SENSOR UNITS, RADIO NAVIGATION RECEIVERS, AND AIR NAVIGATION TECHNIQUE USING SUCH ELEMENTS

(75) Inventors: Jacques Coatantiec, Fauconnieres (FR); Charles Dussurgey, Saint Marcel Les Valence (FR)

(73) Assignee: THALES, Neuilly Sur Seine (FR)

(21) Appl. No.: 12/301,342

(22) PCT Filed: May 21, 2007
(86) PCT No.: PCT/EP2007/054858

§ 371 Date: Jun. 23, 2009

(30) Foreign Application Priority Data
May 19, 2006 (FR) 06 04508

(51) Int. Cl. G01C 21/16; G01S 19/01

(52) U.S. Cl. 701/470; 701/500

(57) ABSTRACT

The present invention relates to an air navigation device with inertial sensor units and radio navigation receivers, and is characterized in that its radio navigation receivers are multiple-constellation receivers and in that their output data are hybridized with the data from the inertial sensor units. According to another feature of the invention, at least some of the inertial sensor units are of MEMS type.

### CROSS-REFERENCE TO RELATED APPLICATIONS

The present Application is based on International Application No. PCT/EP2007/054858, filed on May 21, 2007, which in turn corresponds to French Application No. 0604508, filed on May 19, 2006, and priority is hereby claimed under 35 USC §119 based on these applications. Each of these applications are hereby incorporated by reference in their entirety into the present application.

### BACKGROUND OF THE INVENTION

1. Field of the Invention

The present invention relates to an air navigation device with inertial sensor units and radio navigation receivers, and an air navigation method using such elements.

2. Description of Related Art

An air navigation appliance is known from the European patent 1 326 153 which essentially comprises a primary navigation system, the inertial sensor units of which are based on micromachined sensors (commonly called MEMS), and the positioning device of which is a GPS receiver, and a backup navigation system with gyro laser.

To be able to perform a standalone navigation, that is one that uses only the information from inertial sensor units, in particular for long haul flights, it is necessary for the rate gyros used to have a drift of less than 0.01°/hour. This performance class is also necessary to obtain the requisite heading accuracy. Now, the current MEMS sensors are far from offering such performance levels (they are typically of the order of 0.1°/hour to 1°/hour). The conventional inertial sensor units that can obtain such performance are very costly, heavy and bulky, and their MTBF (mean time between failures) is relatively short (typically 35 000 hours, for the gyrolasers. The fiber optic FOG rate gyros notably improve this aspect, but are still very costly.

### SUMMARY OF THE INVENTION

One object of the present invention is an air navigation device of the type with inertial sensor units and radio navigation receivers that is as inexpensive as possible, while making it possible to obtain the requisite heading accuracy and whose inertial sensor units present a higher MTBF than that of the conventional sensor units and can be arranged in the positions that are most favorable to their operation in the craft in which they are fitted.

Another object of the present invention is an air navigation method making it possible to implement a device that is as inexpensive as possible.

The air navigation device with inertial sensor units and radio navigation receivers according to the invention is characterized in that its radio navigation receivers are multiple-constellation receivers and in that their output data are hybridized with the data from the inertial sensor units. According to another feature of the invention, at least some of the inertial sensor units are of MEMS type.

According to a preferred embodiment, these constellations are those of the GPS and the future GALILEO.

The inventive method is characterized in that it consists in receiving the radio navigation signals from at least two different constellations of positioning satellites and in hybridizing them with the data originating from inertial sensor units.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIGS. 1 and 2 are respectively simplified block diagrams of a first embodiment of a navigation device according to the invention and a variant of this first embodiment,

Figures and 4 are simplified block diagrams of a second embodiment of a navigation device according to the invention and a variant of this second embodiment, respectively,

FIG. 5 is a block diagram of an exemplary implementation of some of the elements of the inventive device in an avionics rack, and

FIG. 6 is a block diagram of a two-antenna variant of the embodiment of FIG. 1.

### DETAILED DESCRIPTION OF THE INVENTION

The device of the present invention is described hereinbelow for a use on board an aircraft, but, of course, it is not limited to this sole use, and it can be used on other craft.

The current systems of inertial sensor units, although they offer performance levels that are sufficient for pure inertial navigation and maintaining the heading of the aircraft for flights of long duration (for example longer than a few hours), are heavy, bulky and very costly. However, the MEMS-type sensor units do not present these drawbacks, but their temporal drift does not allow them to be used to perform a pure inertia navigation and maintain a heading with sufficient accuracy beyond a time period greater than one or two hours (in the best case).

To reconcile these conflicting features and manage to exploit the advantageous qualities of the MEMS sensor units, the present invention provides for combining the data obtained from the MEMS with the information obtained from at least two radio navigation systems. This combination consists mainly in hybridizing these two sorts of data. In practice, although there are currently only two satellite constellations used for navigation (GPS and GLONASS, the latter not however currently being accessible for this purpose), the GALILEO constellation will soon appear, and one or more other constellations may even appear later.

The combination of means of the invention consists essentially in “hybridizing”, according to a technique that is known per se, the data originating from at least two radio navigation receivers relating to different satellite constellations with the data supplied by an inertial measuring unit (IMU) comprising three accelerometers and three rate gyros based on MEMS components.

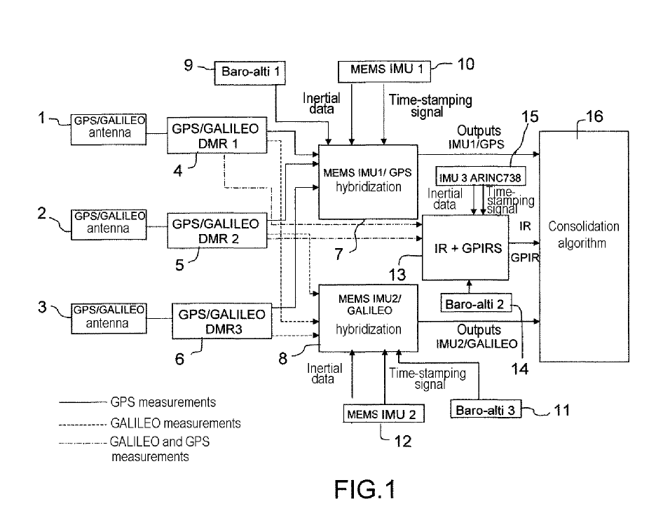

The embodiment of the air navigation device represented in FIG. 1 comprises three two-constellation antennas 1 to 3 respectively each connected to a receiver that is also two-constellation (also called DMR, standing for Dual Mode Receiver), these receivers being respectively referenced 4 to 6. There is thus obtained, as in the other embodiments described hereinbelow, a “triplex” (with three channels) redundant architecture. In the present example, these constellations of positioning satellites are the GPS and future GALILEO constellations, but it is understood that the invention is not limited to two constellations, and that it can use more than two constellations, these constellations possibly being those mentioned above and/or other constellations, provided that the latter are available for such a use, and reliable. In this embodiment, each of the receivers DMR is connected to an antenna capable of receiving both GPS and GALILEO signals. Preferably, each of the receivers DMR is linked to a different antenna, and the antennas are separated from each other by a sufficient distance along the roll axis of the aircraft to make it possible to extract the heading of this aircraft using a two-antenna processing operation that is known per se. The receivers DMR are synchronized with each other (using a common time base which makes it possible to provide measurements synchronously) in order to make it possible to perform the two-antenna processing outside the receiver DMR, and preferably in the processor performing the hybridization calculations between the measurements from the IMU with MEMS and the GPS or GALILEO measurements. In this configuration, each receiver is linked only to one antenna, but each hybridization device is connected to at least two synchronized receivers and thus receives the information from at least two antennas.

The GPS measurement outputs of each of the three receivers 4 to 6 are linked to a first hybridization circuit 7, and their GALILEO measurement outputs are linked to a second hybridization circuit 8. The circuit 7 also receives the data obtained from a baro-altimeter 9 and the inertial data and a time-stamping signal originating from an IMU 10 whose three accelerometers and three rate gyros (not represented) are of MEMS type. Similarly, the circuit 8 also receives the data obtained from a baro-altimeter 11 and the inertial data and a time-stamping signal originating from an IMU 12 whose three accelerometers and three rate gyros (not represented) are of MEMS type. The MEMS can be of “low performance” type with 1°/hour to 10°/hour class rate gyros.

The GPS and GALILEO measurement outputs of two of the three receivers 4 to 6, for example the receivers 4 and 5, are linked to a third hybridization circuit 13. The circuit 13 also receives the data from a third baro-altimeter 14 and the inertial data and a time-stamping signal from an IMU 15. The data supplied by each of the baro-altimeters 9, 11 and 14 are independent of the equivalent data from the other channels. Unlike the IMUs 10 and 12, the IMU 15 does not comprise MEMS, but accelerometers and rate gyros of the class of those fitted in the current civilian so-called ADIRU measuring units (the ADIRUs are “Air Data Inertial Reference Units” comprising an IMU, an computation platform and an “Air Data” unit) and making it possible to achieve performance levels compliant with those described in the ARINC 738 standard thanks to a conventional baro-inertial mechanization known by the name Schüler mechanization. Typically, the order of magnitude of the rate gyro drifts is 0.01°/hour and that of the accelerometric biases is 100 μg, but, of course, these performance levels can be better. If the failure rate affecting the IMU 15 is not sufficiently low to achieve the required availability rate, it may be necessary to add into the airplane architecture a second IMU of the same type. This addition does not alter the principle of the invention.

The measurements supplied by the three hybridization circuits are then consolidated by a consolidation device 16, implementing a consolidation algorithm that is known per se.

The device described hereinabove is capable of operating equally with IMUs with so-called “low performance” MEMS (equipped with 1°/hour to 10°/hour class rate gyros) and with IMUs with so-called “high performance” MEMS (of a class better than 0.1°/hour), and this, thanks to the hybridization of the inertial data with radio navigation data originating from at least two different satellite constellations.

According to a variant of the device of FIG. 1, the IMU 15 of ARINC 738 type is replaced by an ADIRU or two ADIRUs (if the failure rate affecting an ADIRU is too high).

In the other embodiments described hereinbelow, the same elements are assigned the same numerical references.

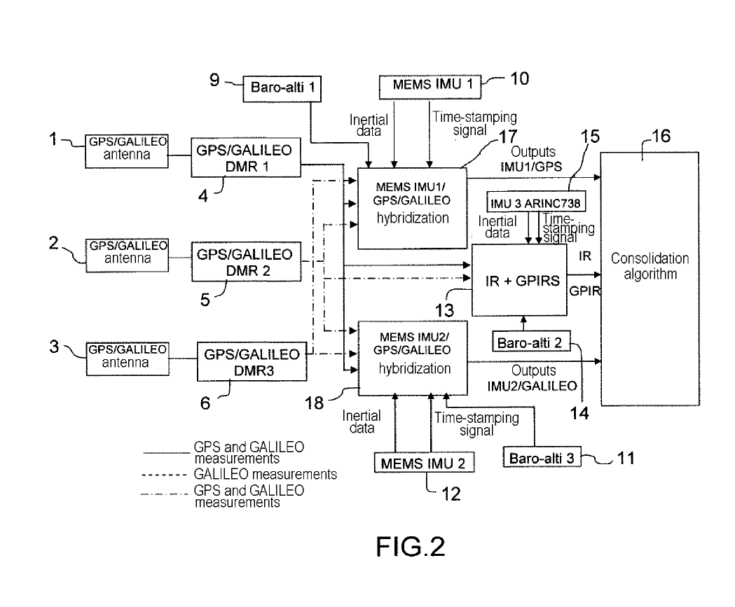

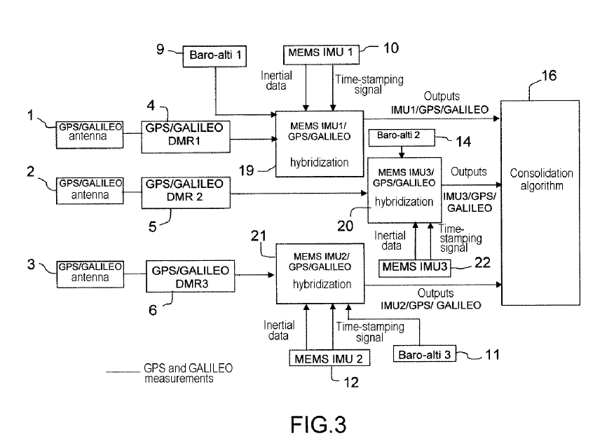

The embodiment of FIG. 2, which is a variant of that of FIG. 1, differs from the latter in that the first two hybridization circuits 17, 18 (respectively replacing the circuits 7 and 8) are identical, and both receive radio navigation data relating to at least two constellations, GPS and GALILEO in the example represented, originating from the three reception channels, and in that the third hybridization device 13 receives radio navigation data relating to at least two constellations, GPS and GALILEO in the example represented, originating from two of the three reception channels. Hybridizing the inertial data originating from the MEMS with the radio navigation data from at least two constellations facilitates the implementation of the “FDE” (Fault Detection and Exclusion, that is, detection and exclusion of the failed constellation) algorithm that protects the navigation device with respect to non-detected constellation failures.

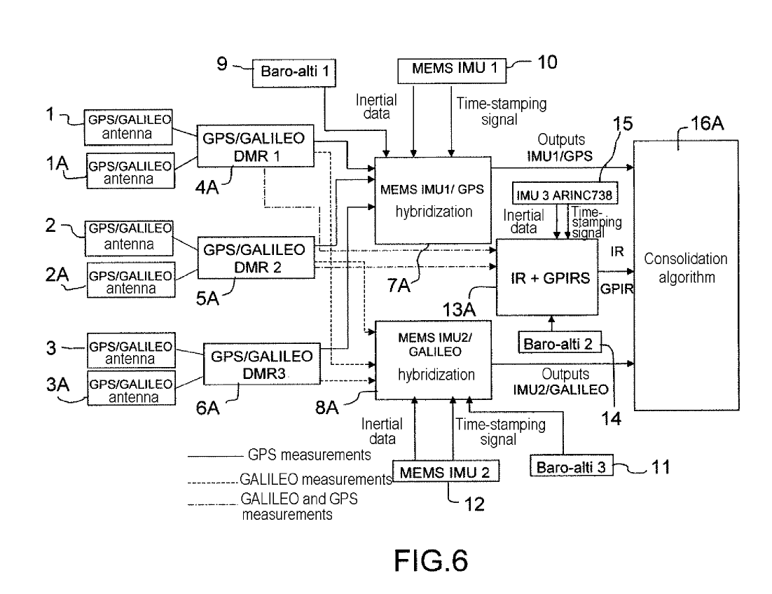

According to another variant of the device of FIG. 1, diagrammatically represented in FIG. 6, in the case of the use of low performance MEMS, each of the receivers DMR is connected to two antennas capable of receiving both the GPS and GALILEO signals. These two antennas are spaced apart along the roll axis of the aircraft by a distance that is sufficient to make it possible to extract the heading information of the aircraft from the GPS and/or GALILEO signals. This extraction can be performed in each receiver DMR or even outside these receivers, using a dedicated computer. However, this solution requires two HF inputs for each receiver DMR. In FIG. 6, the three additional antennas are referenced 1A to 3A. The elements 4A to 8A, 13A and 16A respectively correspond to the elements 4 to 8, 13 and 16, their functions being slightly modified compared to those of the corresponding elements of FIG. 1 because of the measurement of the heading using the two antennas of each channel.

In the embodiment of FIG. 3, the three hybridization circuits 19 to 21 are each linked to a single radio navigation reception channel (respectively comprising the antennas and receivers 1 and 4, 2 and 5, 3 and 6), to an IMU with MEMS (respectively 10, 22 and 21), these three IMUs being identical, and to a baro-altimeter (respectively 9, 14 and 11). Thus, each of these three circuits 19 to 21 hybridizes inertial data with radio navigation measurements obtained from at least two satellite constellations at a time. The measurements produced by the three circuits 19 to 21 are consolidated in the same way as in the case of FIG. 1 by a device 16. As previously, the data supplied by each of the baro-altimeters 9, 11 and 14 are independent of the equivalent data from the other channels.

The embodiment of FIG. 3 is intended to operate with IMUs with so-called “high performance” MEMS, that is MEMS whose rate gyros are of a class better than 0.1°/hour. The benefit of this embodiment is that it makes it possible to reduce the number or the complexity of the radio navigation receivers compared to those of the preceding embodiments. This is made possible thanks to the use of stand alone gyro compasses making it possible to avoid using the measurement of the heading by two antennas linked to each radio navigation receiver.

FIG. 4 represents a variant of the device of FIG. 3. The difference lies in the fact that the device of FIG. 4 comprises only two radio navigation reception channels (antennas and receivers 1, 4 and 2, 5) each linked to the three hybridization devices 19, 20 and 21. However, this variant is less advantageous than the embodiment of FIG. 3 when seeking to maintain high rates of integrity (in order to take into account an undetected hardware failure).

In the embodiments of FIGS. 1 to 4, measurements supplied by the satellite navigation systems (GPS and GALILEO in this case) are either position and speed information resolved into geographic axes, or raw pseudo-measurements (pseudo-distances and pseudo-speeds) generated according to axes relative to the satellites, or the results of the correlations of the signal received by each antenna of the aircraft with codes generated locally in the radio navigation receivers. These correlation results are generally called I and Q.

The corresponding hybridization techniques implemented by the invention are known in the literature as loose hybridization, tight hybridization or ultra-tight hybridization. They are commonly performed using extended Kalman filters, but it is also possible, in the context of the invention, to use non-linear techniques such as those that employ so-called “unscented Kalman filters”, particular filters or, more generally, bayesian filters.

The hybridization algorithms used by the invention make it possible to manage the integrity of the measurements with regard to undetected failures of the constellation used (GPS and/or GALILEO) if the intrinsic integrity of this constellation is not sufficient compared to the overall integrity sought for the measured output variable, and in particular if it is part of the primary variables. In the inventive device, each output variable is accompanied by a protection radius with regard to undetected satellite failures. This is tantamount to saying that the hybridization algorithm is accompanied (if the required integrity level makes it necessary) by an FDE algorithm.

In the case where performance levels of the rate gyros with MEMS do not allow for a standalone alignment by gyro compass, the inventive device has recourse to a method known per se, and comprises means making it possible to extract a heading from the GPS or GALILEO information. To this end, the processor handling the hybridization between the inertial information and the radio navigation information receives the GPS or GALILEO carrier measurement information originating from two antennas spaced apart by a sufficient distance, these measurements being synchronized with each other. Otherwise, that is, when the performance levels of the rate gyros with MEMS do allow for a standalone alignment by gyro compass, there is no need for recourse to a two-antenna system.

In all the embodiments of FIGS. 1 to 4, each measuring channel produces the following information:
angular speed information in three orthogonal directions, preferably combined with the main axes of the aircraft,
linear acceleration information in three orthogonal directions identical to those of the angular speed information, preferably combined with the main axes of the aircraft,
attitude information (roll, pitch and yaw) and heading information,
ground speed information relative to a geographical fix,
position information (latitude, longitude and altitude).

This information is designated here as output information. It will be noted that, in addition to the value of the quantity itself, the FDE algorithm calculates a protection radius (associated with the desired integrity rate) protecting the calculated value with respect to a constellation failure (also called satellite failure) undetected by the constellation management device.

When the GPS signal and the GALILEO signal are available, the output information presents comparable accuracies on the three channels. In the inventive device, all the channels thus play the same role.

In the embodiments of FIGS. 1 and 2, the primary parameters comprise “pure inertia” outputs (or, to be more exact, the values derived from a baro-inertial hybridization with Schüler mechanization, according to the state of the art) produced by the processing subsystem comprising a 2 Nm/hour (95%) class inertia as defined in the ARINC 738 standard. This subsystem can, if necessary, be duplicated. The hybrid data of the first channel (MEMS and GPS) and of the second channel (MEMS/GALILEO) and of the pure inertia channel are statistically independent and make it possible to achieve, by consolidation, the accuracy, the continuity and the integrity level sought. It will be noted that the integrity with respect to satellite failures is managed if necessary by the FDE algorithm associated with the hybridization algorithm. The aim of the consolidation algorithm concerned is to protect the consolidated values with respect to hardware failures. From this point of view, the inventive device must comprise three hardware channels that are independent of each other. It is also necessary for a detected failure to affect only one channel at a time.

Regarding the location parameters, the same considerations are applied to the hybridized data of three channels as to the primary parameters. The consolidation of the output of one channel by the outputs of the other two channels makes it possible to achieve the integrity level sought for the position.

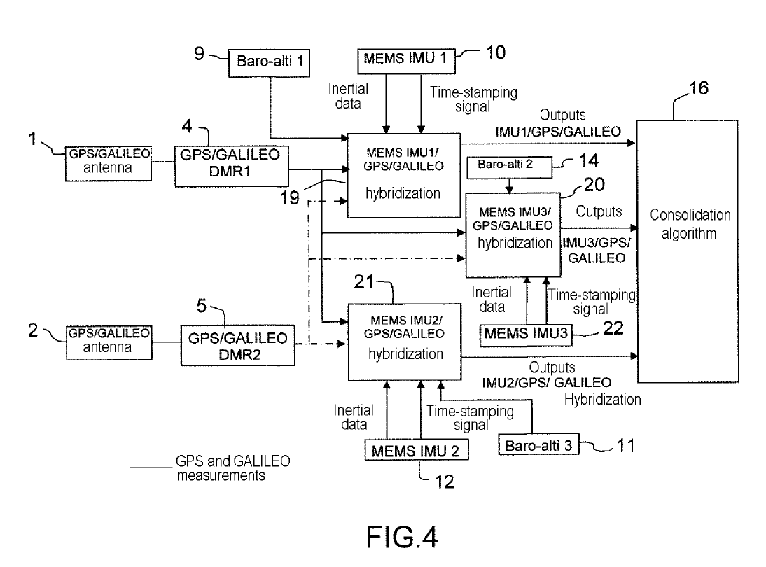

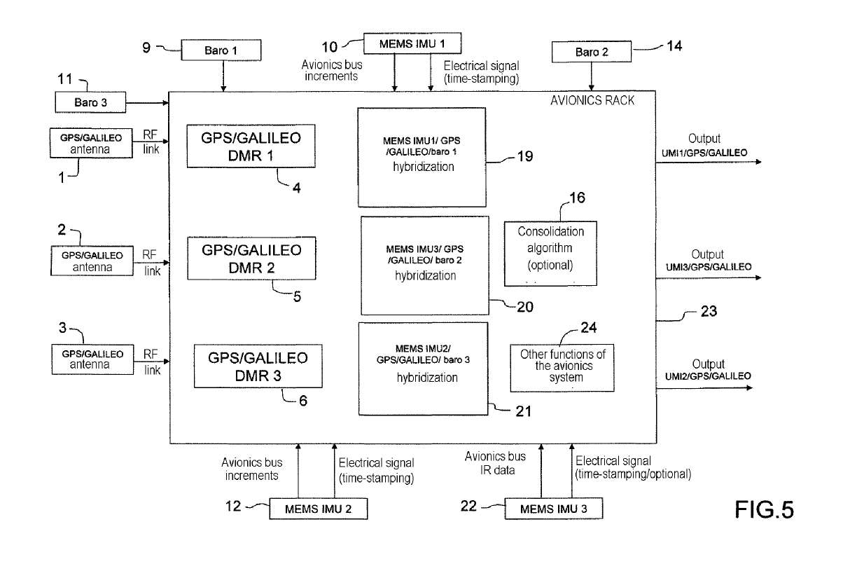

FIG. 5 represents an exemplary hardware distribution of the various elements of the device of FIG. 3, the distributions of the devices of the other figures being deduced therefrom in an obvious manner.

FIG. 5 represents an avionics rack 23 comprising in particular the elements 4 to 6, 19 to 21, 16 and a set 24 of elements handling various avionics functions such as flight management (FMS) for example. The antennas 1 to 3 are linked to the rack 23 by HF links, whereas the elements 9 to 12, 14 and 22 are linked to it by an avionics bus, the time-stamping signals of the IMUs 10, 12 and 22, which are electrical signals, generally passing through a differential serial link.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1-12. (canceled)

13. Air navigation device, comprising:
inertial sensor units; and
radio navigation receivers, wherein said radio navigation receivers are multiple-constellation receivers and their outputs are linked to hybridization devices which are also linked to inertial sensor units, wherein two of the three channels, the inertial measuring units are low performance type MEMS with 1°/hour to 10°/hour class rate gyros, the third channel comprising an inertial measuring unit performing in compliance with standard ARINC 738.

14. The device as claimed in claim 13, wherein said constellations are at least two constellations out of the GPS, GLONASS, future GALILEO constellations and another future constellation.

15. The device as claimed in claim 14, wherein the radio navigation receivers are multiple-constellation receivers and that their outputs are linked to hybridization devices which are also linked to the inertial sensor units.

16. The device as claimed in claim 13, wherein the third channel is duplicated by an identical independent channel.

17. The device as claimed in claim 13, with three measuring channels, characterized in that in the three channels, the inertial measuring units are so-called high performance MEMS, the rate gyros of which are of a class better than 0.1°/hour.

18. The device as claimed in claim 17, wherein each receiver is linked to a single antenna, each hybridization device being linked to at least two synchronized receivers.

19. The device as claimed in claim 13, comprising two radio navigation reception channels, three MEMS inertial measuring units each linked to a hybridization device, each of these three hybridization devices being linked to both reception channels.

20. The device as claimed in claim 13, comprising consolidation means for securing the measurement signals against drifts or failures.

21. An air navigation method with inertial sensor units and radio navigation receivers, according to which the radio navigation signals from at least two different constellations of positioning satellites are received and are hybridized with the data originating from the inertial sensor units, characterized in that, when data is received from inertial sensor units whose rate gyros do not allow for an independent alignment by gyro compass, a heading is extracted from the radio navigation information.

22. The device as claimed in claim 14, wherein the third channel is duplicated by an identical independent channel.

23. The device as claimed in claim 14, with three measuring channels, characterized in that in the three channels, the inertial measuring units are so-called high performance MEMS, the rate gyros of which are of a class better than 0.1°/hour.

24. The device as claimed in claim 15, with three measuring channels, characterized in that in the three channels, the inertial measuring units are so-called high performance MEMS, the rate gyros of which are of a class better than 0.1°/hour.

25. The device as claimed in claim 14, comprising two radio navigation reception channels, three MEMS inertial measuring units each linked to a hybridization device, each of these three hybridization devices being linked to both reception channels.

26. The device as claimed in claim 14, comprising consolidation means for securing the measurement signals against drifts or failures.

27. The device as claimed in claim 15, comprising consolidation means for securing the measurement signals against drifts or failures.

28. The device as claimed in claim 16, comprising consolidation means for securing the measurement signals against drifts or failures.

29. The device as claimed in claim 17, comprising consolidation means for securing the measurement signals against drifts or failures.

30. The device as claimed in claim 18, comprising consolidation means for securing the measurement signals against drifts or failures.

31. The device as claimed in claim 19, comprising consolidation means for securing the measurement signals against drifts or failures.
